(19) United States
(12) Patent Application Publication
(10) Pub. No.: US 2010/0158333 A1
(43) Pub. Date: Jun. 24, 2010

(54) RESOLUTION IMPROVEMENT IN EMISSION OPTICAL PROJECTION TOMOGRAPHY

(75) Inventors: R. Mark Henkelman, Toronto (CA); Jonathan R. Walls, Toronto (CA)

Correspondence Address: HAMRE, SCHUMANN, MUELLER & LARSON, P.C., P.O. BOX 2902, MINNEAPOLIS, MN, 55402-0902, US

(73) Assignee: THE HOSPITAL FOR SICK CHILDREN, Toronto (CA)

(21) Appl. No.: 12/442,083

(22) PCT Filed: Sep. 19, 2007
(86) PCT No.: PCT/CA2007/001637

§ 371 Date: Feb. 10, 2010

Related U.S. Application Data
(60) Provisional application No. 60/845,497, filed on Sep. 19, 2006.

(51) Int. Cl. G06K 9/00

(52) U.S. Cl. 382/131; 382/255

(57) ABSTRACT

A method of reducing blur in an optical projection tomography (OPT) image comprises filtering the frequency space information of OPT image data to reduce the effects of out-of-focus data and defocused in-focus data and reconstructing the filtered OPT data.

### CROSS-REFERENCE TO RELATED APPLICATIONS

This application claims the benefit of U.S. Provisional Application Ser. No. 60/845,497 filed on Sep. 19, 2006 for an invention entitled “Resolution Improvement In Emission Projection Tomography”, the content of which is incorporated herein by reference.

### FIELD OF THE INVENTION

The present invention relates generally to optical projection tomography and in particular to a method of reducing blur in optical projection tomography images and to an optical projection tomography apparatus.

### BACKGROUND OF THE INVENTION

Rapid advances in genetic research using animal models have driven the demand for three-dimensional (3D) biological imaging of small specimens. Three-dimensional visualization of whole organs or organisms is often used to gain a better understanding of the development of complex anatomy. Information pertaining to the time and location of gene expression throughout a complete organism is also crucial for understanding developmental genetics.

As a result, there is an increased demand on imaging techniques to have large specimen coverage, cellular-level resolution and molecular specificity. Several techniques have been developed to achieve this end. For example, the selective plane illumination microscopy technique as described in “Optical Sectioning Deep Inside Live Embryos By Selective Plane Illumination Microscope” authored by Huisken et al. and published in Science, Volume 305, pages 1007 to 1009, 2004, illuminates a specimen with a sheet of excitation light and images the emitted fluorescence with an orthogonal camera-based detection system. Unfortunately this technique cannot accommodate absorbing molecular markers commonly used with brightfield microscopy.

Block-face or episcopic imaging as described in “Phenotyping Transgenic Embryos: A Rapid 3-D Screening Method Based On Episcopic Fluorescence Image Capturing” authored by Weninger et al. and published in Nat. Genet., Volume 30, pages 59 to 65, 2002, and surface imaging microscopy as described by Ewald 2002, embed a sample, image its surface, remove the imaged layer, and continue the process with the newly exposed tissue. Unfortunately, these techniques are time consuming and prevent the use of the sample for further analysis by other means.

Optical projection tomography (OPT) as described in “Optical Projection Tomography As A Tool For 3D Microscopy And Gene Expression Studies” authored by Sharpe et al. and published in Science, Volume 296, pages 541 to 545, 2002, is a relatively new technology that obtains cellular level resolution and large specimen coverage (1 cubic centimetre), and is able to use both absorbing and fluorescent molecular markers. Use of this technology for biological studies in model organisms is increasing as will be appreciated from the following non-patent references:

“Foxh1 Is Essential For Development Of The Anterior Heart Field” authored by von Both et al. and published in Dev. Cell, Volume 7, pages 331 to 345, 2004;

“Baf60c Is Essential For Function Of BAF Chromatin Remodelling Complexes In Heart Development” authored by Lickert et al. and published in Nature, Volume 431, pages 107 to 122, 2004;

“3 Dimensional Modelling Of Early Human Brain Development Using Optical Projection Tomography” authored by Kerwin et al. and published in BMC Neuro., Volume 5, page 27, 2004; and

“Bapx1 Regulates Patterning In The Middle Ear: Altered Regulatory Role In The Transition From The Proximal Jaw During Vertebrate Evolution” authored by Tucker et al. and published in Development, Volume 131, pages 1235 to 1245, 2004.

OPT is also described in various patent references. For example, U.S. Patent Application Publication No. 2004/0207840 to Sharpe et al. discloses a rotary stage for use in optical projection tomography. The rotary stage comprises a stepper motor with a rotatable vertical shaft, the lower end of which carries a specimen to be imaged so that the specimen is rotated about a substantially vertical axis. The stepper motor is mounted on a table, the position of which is accurately adjustable in tilt and in vertical position to ensure that the rotational axis of the specimen is perpendicular to the optical axis. The specimen rotates within a stationary chamber and the rotary stage is used with a microscope which provides a three-dimensional image of the specimen.

U.S. Patent Application Publication No. 2006/0093200 to Sharpe et al. discloses an apparatus for obtaining an image of a specimen by optical projection tomography. The apparatus comprises a confocal microscope which produces a light beam which scans the specimen whilst the latter is supported on a rotary stage. Light passing through the specimen is passed through a convex lens which directs, onto a central light detector of an array of detectors, light which exits or by-passes the specimen parallel to the beam incident on the specimen.

U.S. Patent Application Publication No. 2005/0085721 to Fauver et al. discloses a fixed or variable motion optical tomography system that acquires a projection image of a sample. The sample is rotated about a tube axis to generate additional projections. Once image acquisition is completed, the acquired shadowgrams or image projections are corrected for errors. A computer or other equivalent processor is used to compute filtered backprojection information for three-dimensional reconstruction.

U.S. Patent Application Publication No. 2006/0096358 to Fauver et al. discloses an optical projection tomography microscope comprising a cylindrical container inserted into at least one pair of polymer grippers. A motor is coupled to rotate the cylindrical container.

U.S. Pat. No. 6,944,322 to Johnson et al. discloses a parallel-beam optical tomography system comprising a parallel ray beam radiation source that illuminates an object of interest with a plurality of parallel radiation beams. After passing through the object of interest, the pattern of transmitted or emitted radiation intensities is magnified by a post specimen optical element or elements. An object containing tube is located within an outer tube, wherein the object of interest is held within or flows through the object containing tube. A motor may be coupled to rotate and/or translate the object containing tube to present differing views of the object of interest. One or more detector arrays are located to receive the emerging radiation from the post specimen magnifying optical element or elements. Two or three-dimensional images may be reconstructed from the magnified parallel projection data.

Although OPT provides for effective imaging, reconstructed OPT images suffer from blurring that worsens with increasing distance from the rotational axis of the specimen or sample. This blur is due in part to the collection of images with varying degrees of defocus inherent in optical imaging. In any given optical image, the specimen at the focal plane is in best focus, the specimen within the depth of field is considered to be in focus, and the specimen outside of the depth of field is considered to be out of focus.

Specimens in OPT imaging are normally positioned such that half of the specimen is positioned within the depth of field of the OPT apparatus, and the other half of the specimen is positioned outside of the depth of field of the OPT apparatus. As a result, some out-of-focus data from the half of the specimen outside of the depth of field is superimposed on the in-focus data from the half of the specimen within the depth of field. This out-of-focus data is included in the filtered back projection reconstruction process used to construct the resultant 3D volumetric image of the specimen and contributes to lack of focus in the resultant reconstructed 3D image.

Other microscopic imaging techniques face similar issues with out-of-focus data. For example, confocal microscopy as described in the “Handbook Of Biological Confocal Microscopy”, 2^{nd} Edition, 1995, New York: Plenum Press, authored by Pawley, attempts to remove as much out-of-focus data as possible by using a pinhole at the detector plane conjugate to the focal plane, so as to exclude as much out-of-focus light as possible. Deconvolution microscopy as described in “Three-Dimensional Imaging By Deconvolution Microscopy” authored by McNally et al. and published in Methods, Volume 19, pages 373 to 385, 1999, deals with the out-of-focus data by deconvolving the 3D point spread function (PSF) of the optical system from a series of images with different positions of the focal plane throughout the specimen.

Unfortunately, these techniques to deal with out-of-focus data are not applicable to OPT. Using a point-sampling technique with OPT would significantly increase imaging time and negate one of its key strengths. Direct deconvolution of the 3D PSF is complicated by the rotation of the specimen during imaging and thus, the differing projection angles of the OPT views.

As will be appreciated improvements in OPT to enhance resolution of reconstructed 3D volumetric images are desired. It is therefore an object of the present invention to provide a novel method of reducing blur in optical projection tomography images and a novel optical projection tomography apparatus.

### SUMMARY OF THE INVENTION

According to one aspect, there is provided a method of reducing blur in an optical projection tomography (OPT) image comprising:

filtering the frequency space information of OPT image data to reduce the effects of out-of-focus data and defocused in-focus data; and

reconstructing the filtered OPT data.

In one embodiment, the filtering also reduces the effects of defocused in-focus data. The filtering excludes out-of-focus data and narrows the point spread function of in-focus data. The filtered OPT data are OPT sinograms.

The filtering may further comprise deemphasizing noise. For example, frequency components dominated primarily by noise may be deemphasized. This can be achieved by excluding high frequency components that contain no data. Noise in gaps at certain frequencies can also be inhibited from being emphasized. During the inhibiting, filtering vectors are scaled by a weighting function.

According to another aspect, there is provided an optical projection tomography apparatus comprising:

a light source;

optics for focusing light emitted by the light source onto a specimen thereby to illuminate said specimen, said specimen being rotated through steps;

a microscope gathering light from said illuminated specimen at each step;

an image sensor receiving the gathered light from said microscope at each step and generating OPT image data; and

processing structure processing the OPT image data to reduce at least the effect of out-of-focus data and reconstructing the processed OPT image data thereby to yield a volumetric representation of said specimen.

In one embodiment, the processing structure processes the OPT image data to reduce the effects of in-focus data that has been defocused. In this case, the processing structure processes the OPT image data to exclude out-of-focus data and to narrow the point spread function of in-focus data. The processing structure employs a multi-component filter to process the OPT image data. The multi-component filter deemphasizes noise in the OPT image data. In one embodiment, the multi-component filter comprises four components, namely a max-limited recovery filter, a bandlimiting roll-off filter at high frequencies, a Wiener filter and a sloped-based roll-off filter.

A computer readable medium embodying a computer program comprising computer program code that when executed performs the above method is also provided.

### BRIEF DESCRIPTION OF THE DRAWINGS

Embodiments will now be described more fully with reference to the accompanying drawings in which:

FIG. 1a is a schematic diagram of an OPT apparatus;

FIG. 1b shows the depth of field of the OPT apparatus of FIG. 1a;

FIG. 2 is a conventional optical projection tomography (OPT) reconstruction of vascular passing through the torso of a mouse embryo;

FIG. 3a is an OPT sinogram of a point source;

FIG. 3b is an OPT sinogram based on the in-focus data of the OPT sinogram of FIG. 3a;

FIG. 3c is an OPT sinogram based on the out-of-focus data of the OPT sinogram of FIG. 3a;

FIG. 3d is a reconstruction of the OPT sinogram of FIG. 3a;

FIG. 3e is a reconstruction of the in-focus OPT sinogram of FIG. 3b;

FIG. 3f is a reconstruction of the out-of-focus OPT sinogram of

FIG. 3c;

FIG. 3g is a magnitude image of the two-dimensional (2D) Fourier Transform (FT) of the OPT sinogram of FIG. 3a;

FIGS. 3h and 3i are magnitude images of the 2D FT of the OPT sinograms of FIGS. 3b and 3c respectively;

FIG. 4a is the distance-dependent point spread function (PSF) in an OPT sinogram of a point source separated in the Fourier space;

FIG. 4b is a magnitude image of the 2D FT of the OPT sinogram of FIG. 4a;

FIG. 4c is the PSF recorded at a given view angle;

FIG. 4d is a one-dimensional (1D) FT taken transverse to the beam axis of the PSF of FIG. 4c;

FIG. 5a is a reconstruction of the OPT sinogram of a point source;

FIG. 5b is a filtered reconstruction of the OPT sinogram of the point source;

FIGS. 5c and 5d are contour plots showing the reconstructions of FIGS. 5a and 5b respectively, at 20%, 50% and 80% maximum value;

FIGS. 6a and 6b are plots through the radial and tangential axes of the reconstruction of FIG. 5a;

FIGS. 6c and 6d are plots through the radial and tangential axes of the filtered reconstruction of FIG. 5b;

FIGS. 7a to 7c are contour plots of the X-Y, Y-Z and X-Z planes in an OPT reconstruction of a subresolution bead, the contour lines drawn at 20%, 50% and 80% maximum value;

FIGS. 7d to 7f are contour plots of the X-Y, Y-Z and X-Z planes in a filtered OPT reconstruction of the subresolution bead, the contour lines drawn at 20%, 50% and 80% maximum value;

FIG. 8a is an OPT reconstruction of vascular passing through the torso of a mouse embryo identical to FIG. 1;

FIGS. 8b and 8c are OPT reconstructions along orthogonal planes passing through the mouse embryo cardiac system and tail and through the mouse embryo tail and limb buds respectively; and

FIGS. 8d to 8f show corresponding reconstructions from filtered OPT sinograms.

### DETAILED DESCRIPTION OF THE EMBODIMENTS

Turning now to FIG. 1 a, an optical projection tomography (OPT) apparatus is shown and is generally identified by reference numeral 10. As can be seen, OPT apparatus 10 comprises a light source 12, in this embodiment a mercury vapour arc lamp, that directs widefield illumination towards a lens 14. The lens 14 in turn focuses the widefield illumination onto a specimen 16 within a container 18. The container 18 has optically flat parallel windows and contains a 1:2 mixture of benzyl alcohol and benzyl benzoate (BABB) therein. The container 18 is rotatable about an axis of rotation that is perpendicular to the optical axis of the OPT apparatus 10 to enable the specimen 16 to be imaged at multiple angles. In this embodiment, the specimen is small (1 cc) and semi-transparent and is embedded in agarose. The refractive index of the embedded specimen is matched with the BABB mixture within the container 18.

Fluorescent photons emitted from fluorophores throughout the specimen 16 that have been excited by the widefield illumination focused onto the specimen, are collected by a microscope 20. The fluorescent photons are separated from incident illumination by a chromatic filter and focused onto a cooled, charge coupled device (CCD) detector array 22 where an image of the specimen 16 is recorded. Cooling of the CCD detector array 22 assists in reducing noise and increasing detection efficiency. The image data of the CCD detector array 22 is applied to processing structure 24 that executes OPT image data processing software. The processing structure 24 processes the OPT image data resulting in a 3D volumetric representation or reconstruction of the specimen 16 that has improved resolution as compared to the prior art. The processing structure 24 may be integral with the other components of the OPT apparatus 10 or may be separate downstream processing equipment, such as for example a personal computer, that receives the image data output of the CCD detector array 22 via a direct bus or wireless connection or via a wired or wireless local or wide area network connection.

The data recorded by each pixel of the CCD detector array 22 comes from a narrow cone of light, as defined by the lens that approximates a strip integral projection through the specimen 16. The axes of all the cones of light collected by the pixels in a CCD detector array frame diverge by less than 0.3 degrees and can be approximated as parallel ray projections through the specimen 16. An image of the specimen 16 at any given rotation angle is termed an OPT view. Each OPT view recorded by the CCD detector array 22 represents the integrated intensity of fluorescence projected along parallel rays through the specimen 16.

During imaging of the specimen 16, the specimen is rotated stepwise through a complete revolution with OPT views acquired at each step. The rows of pixels of the CCD detector array 22 are aligned perpendicularly to the rotational axis of the container 18. A complete revolution of the container 18 permits in-focus data from all parts of the specimen 16 to be obtained thereby to provide for unambiguous 3D reconstruction. The temporal sequence from a row of pixels of the CCD detector array 22 forms an OPT sinogram that reconstructs the corresponding slice using a standard convolution filtered back-projection algorithm as described in “Principles Of Computerized Tomographic Imaging”, New York: IEEE Press, 1988 and authored by Slaney et al. A 3D volumetric representation of the specimen 16 is obtained by reconstructing the OPT sinograms corresponding to all of the slices. As will be apparent to those of skill in the art, because all of the rays are approximately parallel, reconstruction of the OPT sinograms does not require a cone beam reconstruction, as described in “Practical Cone-Beam Algorithm” authored by Feldkamp et al. and published in J. Optical Society Am., Volume 1, pages 612 to 619, 1984.

In all OPT views, there is a limited region of the specimen 16, defined by the depth of field (DOF) of the OPT apparatus 10, over which the specimen 16 is in acceptable focus. Any part of the specimen 16 positioned outside of the depth of field of the OPT apparatus 10 at a given view angle is out of focus in that recorded OPT view. In the OPT apparatus 10, the focal plane is positioned such that it is approximately halfway between the nearest point of the specimen 16 to the CCD detector array 22 and the rotation axis of the container 18. FIG. 1b shows the specimen 16, the focal plane and the depth of view of the OPT apparatus 10. Thus, each OPT view comprises in-focus data from the half of the specimen 16 that is proximate the CCD detector array 22 and out-of-focus data from the remote half of the specimen 16 that is superimposed on the in-focus data.

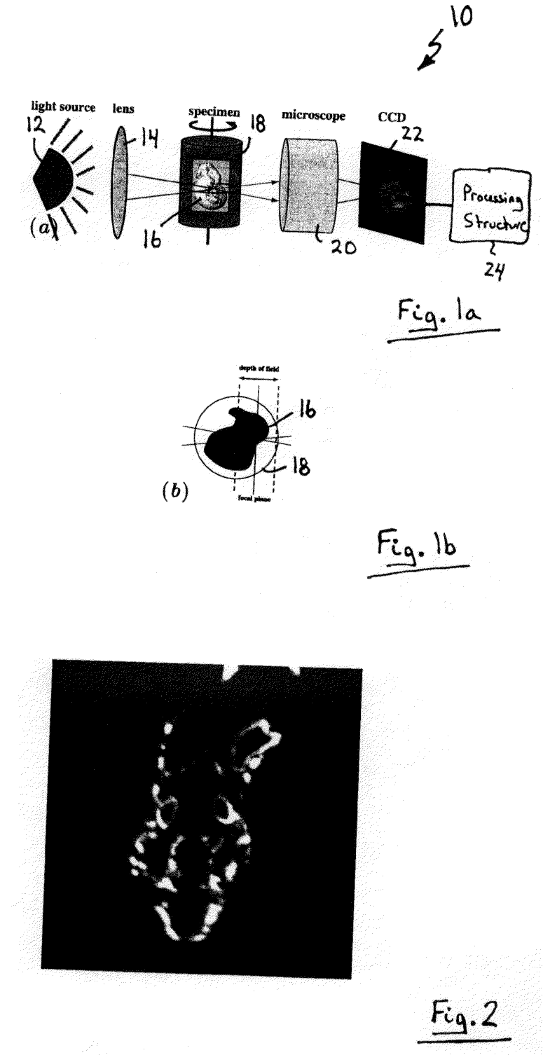

In conventional OPT apparatuses, this out-of-focus data is included in the filtered back-projection reconstruction process and contributes to lack of focus in the resultant reconstructed 3D image. For example, FIG. 2 is a resultant 3D reconstruction of vascular passing through the torso of a mouse embryo that is blurry as a result of out-of-focus data superimposed on in-focus data. As will be appreciated, the blur in the resultant 3D reconstruction does not permit all of the different components of the specimen 16 to be distinguished. To improve resolution and reduce blur in resultant 3D reconstructions, in the OPT apparatus 10 the OPT sinograms are processed by the processing structure 24 prior to reconstruction to reduce the adverse effects of at least the out-of-focus data. In particular, in this embodiment, during OPT sinogram processing, the frequency space information of the OPT sinograms is filtered to exclude out-of-focus data and to narrow the point spread function of in-focus data prior to reconstruction of the OPT sinograms. Further specifics of this blur reduction technique will now be described. However, before doing so, for ease of understanding, a discussion of underlying theory will firstly be provided.

The r_{Airy} resolution of an optical system such as the OPT apparatus 10, is the minimum distance of separation necessary between two point sources such that their images can still be resolved according to the Rayleigh criterion as described in the previously mentioned Pawley reference. This distance is limited by the point spread function (PSF) of the OPT apparatus 10, that is, the Airy diffraction pattern, for which the radius of the first dark ring is given by Equation 1 below:

$${r}_{Airy} = \frac{0.61 n λ}{NA} , \qquad ( 1 )$$

where:

n is the refractive index of the immersion medium of the lens (in this case for air);

λ is the wavelength of the light emitted by the light source 12; and

NA is the numerical aperture of the OPT apparatus 10.

The PSF of the lens is not invariant over the specimen 16, but varies according to the distance between the specimen and the focal plane of the OPT apparatus 10. As a result, the resolution r_{Airy} applies only at the focal plane of the OPT apparatus 10. Away from the focal plane, the resolution deteriorates.

Portions of the specimen 16 located within the depth of field of the OPT apparatus 10 are considered to be in focus, but not at best focus. Any portion of the specimen 16 beyond the depth of field is out of focus. The depth of field (DOF) is given by Equation 2 below:

$$DOF = {n}_{bath} ( \frac{n λ}{{NA}^{2}} + \frac{n}{MNA} e ) \qquad ( 2 )$$

where:

M is the lateral magnification of the OPT apparatus 10;

e is the pixel size of the CCD detector array 22; and

n_{bath} is the refractive index of the medium in which the specimen 16 rests, included to account for the effect of foreshortening along the optical axis of the OPT apparatus.

The first term in Equation 2 is the wave depth of field and accounts for defocus of the interference pattern, while the second term in Equation 2 is the geometrical depth of field and accounts for the effect of the so-called circle of confusion that dominates at lower numerical apertures or large detector element size.

According to the Nyquist criterion of sampling frequency, the Airy disk must be sampled with a detector element spacing that is less than half this distance in order to avoid aliasing and any associated artefacts as described in the previously mentioned Slaney reference. This requires the spacing of the detector elements in the CCD detector array 22 to be expressed by Equation 3 below:

$$e \leq M \frac{{r}_{Airy}}{2} \qquad ( 3 )$$

Equation 3 can be substituted into Equation 2 to determine the maximum possible depth of field as expressed by Equation 4 below:

$${DOF}_{ma x} = {n}_{bath} ( \frac{n λ}{{NA}^{2}} + \frac{n}{MNA} M \frac{{r}_{Airy}}{2} ) \\ or \\ {DOF}_{ma x} = {n}_{bath} ( \frac{n λ}{{NA}^{2}} + \frac{0.61 {n}^{2} λ}{2 {NA}^{2}} ) \qquad ( 4 )$$

Assuming an air immersion medium for the lens (n˜1), the maximum depth of field is given by Equation 5 below:

$${DOF}_{ma x} = {n}_{bath} ( \frac{1.305 λ}{{NA}^{2}} ) \qquad ( 5 )$$

Typically, the depth of field is equal to or larger than half the maximum specimen extent dₘₐₓ, or:

$$DOF \geq \frac{{d}_{ma x}}{2} \qquad ( 6 )$$

A point source positioned at any radius from the rotational axis of the container 18 is in focus for one half of a revolution, and out of focus for the other half of the revolution. Portions of the specimen 16 positioned at less than half the distance of the depth of field from the rotational axis of the container 18 are never imaged at best focus, and portions of the specimen 16 positioned beyond that distance experience best focus at two positions in one revolution.

As a result, a conventional reconstructed 3D image is based on images of the specimen with varying amounts of defocus due to the varying PSF, with only a few images obtained during each complete revolution comprising best focus data.

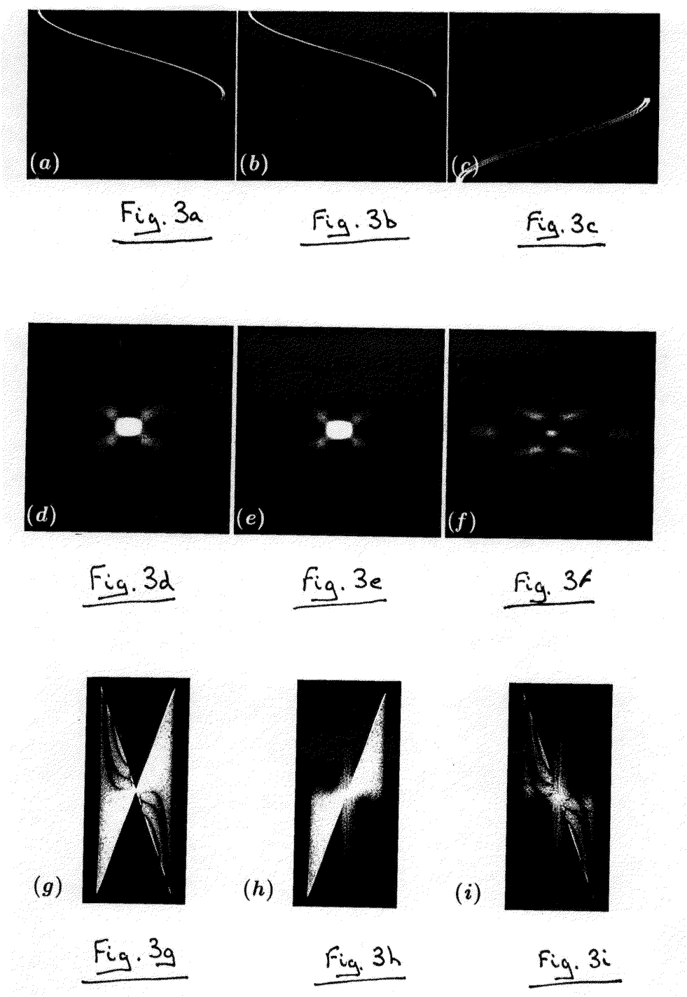

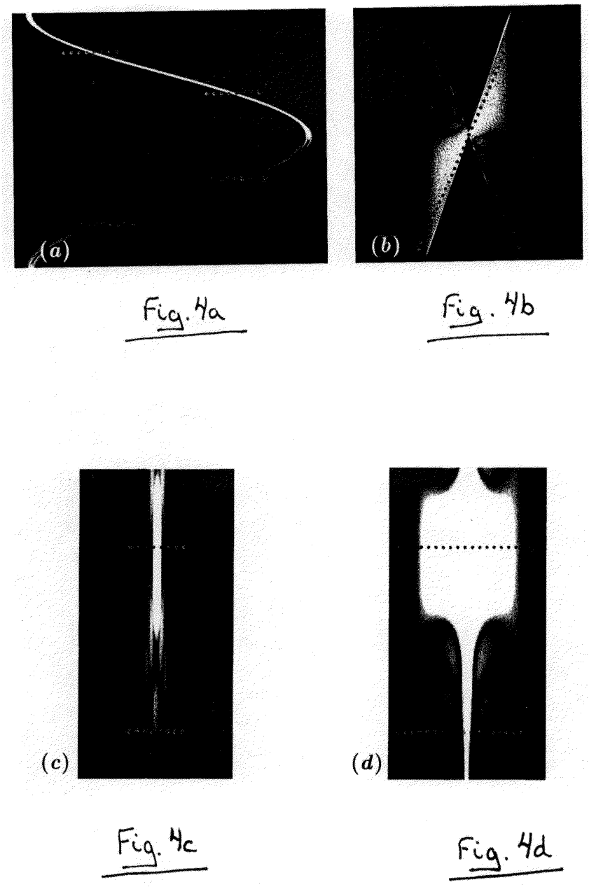

The varying PSF in a simulated OPT sinogram of a point source is illustrated in FIG. 3a. This two-dimensional (2D) example is representative of a row of detector elements in the CCD detector array 22, and is sufficient for illustrating the principles for processing out-of-focus data. The image of the point source is in best focus when the point source is coincident with the focal plane of the OPT apparatus 10, begins to defocus as the point source moves away from the focal plane of the OPT apparatus, and is out of focus when the point source moves out of the depth of field of the OPT apparatus 10 entirely.

The influence of the out-of-focus data on the point source reconstruction can be examined by splitting the OPT sinogram of FIG. 3a into two halves, namely an OPT sinogram based only on the in-focus data from the specimen 16 positioned within the depth of field, and an OPT sinogram based only on the out-of-focus data from the specimen 16 positioned beyond the depth of field. FIG. 3b shows the OPT sinogram based only on the in-focus data and FIG. 3c shows the OPT sinogram based only on the out-of-focus data. The OPT sinograms of FIGS. 3b and 3c comprise one half of the OPT views for a complete revolution, which is sufficient to reconstruct the point source. The resultant 3D reconstruction based on the OPT sinograms of FIGS. 3b and 3c is shown in FIG. 3d and results in a blurred PSF. Resultant 3D reconstructions of the in-focus and out-of-focus OPT sinograms are shown in FIGS. 3e and 3f. Unsurprisingly, the reconstruction of the out-of-focus OPT sinogram is significantly blurrier than the reconstruction of the in-focus OPT sinogram. The resultant 3D reconstruction of FIG. 3d is the linear addition of the in-focus and out-of-focus OPT sinograms of FIGS. 3e and 3f. As will be appreciated, removing the out-of-focus data from the OPT sinograms decreases the reconstruction blur.

It should be noted that the reconstruction using only the in-focus OPT sinogram is not significantly different from that of the complete 3D reconstruction, due to the defocusing of the PSF while the point source is within the depth of field. Thus, merely excluding the out-of-focus data does not provide the desired resolution improvement. As a result, in addition to excluding the out-of-focus data, defocusing of the in-focus data is also reduced in order to obtain higher quality reconstructed images.

A typical OPT sinogram involves many point sources, and the images of these point sources often overlap as the specimen 16 completes a revolution. Separating the out-of-focus data from a typical OPT sinogram is not as simple as in FIG. 3a, which deals with an isolated point source. However, quantitative information about the distance of any point source to the detector elements of the CCD detector array 22 is encoded in the OPT sinogram and can be disentangled by calculating the 2D Fourier Transform (FT) of the OPT sinogram. As shown in FIG. 3g, the 2D FT of the OPT sinogram of FIG. 3a resembles a bowtie. The 2D FT of the in-focus OPT sinogram of FIG. 3b is shown in FIG. 3h and is represented almost exclusively in the lower left and upper right quadrants. The 2D FT of the out-of-focus OPT sinogram of FIG. 3c is shown in FIG. 3i and appears almost exclusively in the upper left and lower right quadrants. Just as the complete OPT sinogram is the linear sum of the in-focus and out-of-focus OPT sinograms, so are the corresponding 2D FTs. Information about point source-to-detector array distance is then separable in the FTs of the OPT sinograms.

The above concept is referred to as the frequency-distance relationship (FDR) of the OPT sinogram and its Fourier Transform, and was developed for single photon emitted computed tomography (SPECT), an imaging modality that also suffers from a spatially varying PSF, as described in “Fourier Correction For Spatially Variant Collimator Blurring In SPECT” authored by Xia et al. and published in IEEE Trans. Med. Im., Volume 14, pages 100 to 115, 1995. Briefly, the FDR states that points in the specimen at a specific source-to-detector array distance l over all projection angles φ in the sinogram space (r, φ), where r is the axis of the detector element, provide the most significant contribution to the 2D FT of the sinogram along the slope l=−Φ/R, in the Fourier space (R, Φ).

FIG. 4a shows the distance-dependent PSF in an OPT sinogram of a point source that can be separated in Fourier space. FIG. 4b is a magnitude image of the 2D FT of the OPT sinogram. FIG. 4c is the PSF recorded at a given view angle and at a given source-to-detector array distance. FIG. 4d is a magnitude image of the 1D FT taken transverse to the beam axis of the PSF. In the particular case of a point source, the line with the maximum slope in the 2D FT of the OPT sinogram is approximately equal to the 1D FT of the PSF nearest the CCD detector array 22, and the line with the most negative slope is approximately equal to the 1D FT of the PSF furthest from the CCD detector array 22. As expected, the lines with slopes in between this maximum and minimum are approximately equal to the corresponding position as denoted by the dotted lines in these Figures. The PSF along the lines in FIGS. 4a and 4c are approximately equal and the PSF along the lines in FIGS. 4d and 4d are approximately equal. The full range of distance dependent PSFs are separated along lines of corresponding slopes in the 2D FT of the OPT sinogram. This separation in Fourier space enables the construction of an inverse filter that permits unblurred OPT sinograms to be recovered by deconvolving the distance dependent PSF from the blurred OPT sinograms.

The 3D FDR has been described in “Noniterative Compensation For The Distance-Dependent Detector Response and Photon Attenuation in SPECT Imaging” authored by Glick et al. and published in IEEE Trans. Med. Im., Volume 13, pages 363 to 374, 1994, according to Equation 7 below:

$$P ( {R}_{x} , {R}_{z} , Φ ) = {H ( {R}_{x} , {R}_{z} , l = - \frac{Φ}{{R}_{x}} )}^{- 1} {P}_{b} ( {R}_{x} , {R}_{z} , Φ ) \qquad ( 7 )$$

where:

(Rₓ, R_{z}, Φ) is the Fourier equivalent of the OPT sinogram space (rₓ, r_{z}, φ);

(rₓ, r_{z}) are the axes of the CCD detector array row and detector element respectively;

l is the slope of the line in the (Rₓ, Φ) plane and also the distance of the source from the CCD detector array 22;

P_{b}(Rₓ, R_{z}, Φ) is the blurred OPT sinogram;

P(Rₓ, R_{z}, Φ) is the unblurred OPT sinogram; and

H/(Rₓ, R_{z}, l=−Φ/Rₓ) is the FT of the distance dependent PSF, and is evaluated at each sample (Rₓ, R_{z}, Φ) using the FDR.

The constructed inverse filter H⁻¹ comprises four distinct components, namely a max-limited recovery filter designed according to the FDR, a bandlimiting roll-off filter at high frequencies, a Wiener filter to deemphasize noise, and a slope-based roll-off filter to exclude out-of-focus data. During construction of the inverse filter H⁻¹, the 2D PSF of the lens covering the full range of possible specimen positions is calculated. The 2D FT of the 2D PSFs is then calculated to create a stack of 2D data with the coordinate system (Rₓ, R_{z}, l). At each position (Rₓ, R_{z}, Φ) in H, the corresponding value from the FTs in coordinate system (Rₓ, R_{z}, l) is taken using the relation l=−Φ/Rₓ. The filter H is then inverted thereby to yield H.

The highest frequencies in the FT of the lens PSF contain the least amount of energy and the frequencies beyond the bandlimit of the lens contain no energy at all. The inverse filter H⁻¹ strongly emphasizes these values, which in the acquired OPT data are dominated by noise. These highest frequency values are rolled down to zero from 90% of the bandlimit of the lens to 100% of the bandlimit, according to Equation 8 below:

$${W}_{{b}_{x}} ( {R}_{x} , {R}_{z} , Φ ) = \{ \begin{matrix}1.0 \text{:} & R < 0.90 b \\ {cos}^{2} ( \frac{π}{2} \frac{{R}_{x} - 0.90 b}{0.1 b} ) \text{:} & b > {R}_{x} > 0.90 b \\ 0.0 \text{:} & {R}_{x} > B\end{matrix} \qquad ( 8 )$$

where:

b is the bandlimit of the lens.

The same weighting W_{b} is used in the R_{z} direction. The final bandwidth roll-off filter is W_{b}=W_{bx}W_{bz}.

Any deconvolution in frequency space data risks overemphasizing noise, especially in the high frequency region where noise dominates the signal. The Wiener filter is commonly used to avoid this problem by deemphasizing the frequencies that are mostly noise as described in “A Weiner Filter For Nuclear Medicine Images authored by King et al. and published in Med. Phys., Volume 10, pages 876 to 880, 1983. The Wiener filter can be expressed by Equation 9 below:

$${W}_{W} ( {R}_{x} , {R}_{z} , Φ ) = \frac{{P}_{s }}{{P}_{s} + {P}_{n}} \qquad ( 9 )$$

where:

Pₛ is the power spectrum of the signal; and

Pₙ is the power spectrum of the noise.

For data with Poisson noise, Pₙ can be assumed to be constant over all frequencies as described in “Fundamental Limitations In Linear Invariant Restoration Of Atmospherically Degraded Images authored by Goodman et al. and published in SPIE J., Volume 75, pages 141 to 154, 1976. Pₙ can be estimated by averaging the highest frequency components of the recorded OPT data, where no signal is expected. The power spectrum of the signal can be estimated by radially averaging the power spectrum of the acquired OPT data, subtracting the power spectrum of the noise, and resampling the radial average to the 3D grid. Although this provides an adequate estimation of the power spectrum of the signal, information about the 2D details of the OPT sinogram FT may be lost.

The FT of the 2D PSF of the lens demonstrates gaps of information at certain frequency values, as shown in FIG. 4d. These gaps first appear at source-to-detector array distances located slightly beyond the extent of the wave depth of field (Equation 2), and become more dominant as the source-to-detector array distance is increased. The inverse filter strongly emphasizes these regions of the OPT sinogram FT and as a result, emphasizes noise from the acquired OPT data.

To avoid the overemphasis of noise in these information gaps, the vectors in the FDR inverse filter H⁻¹ are scaled by a weighting factor according to Equation 10 below:

$$\vert {H}_{li m}^{- 1} \vert = \{ \begin{matrix}\vert {H}^{- 1} \vert \text{:} & \vert {H}^{- 1} \vert < max - roll \\ max - roll * {e}^{- ( \vert {H}^{- 1} \vert - ma x )} \text{:} & \vert {H}^{- 1} \vert > max - roll\end{matrix} \qquad ( 10 )$$

where:

|H⁻¹| is the magnitude value of the constructed inverse filter;

|Hₗᵢₘ⁻¹| is the magnitude value of the limited inverse filter;

max is the maximum magnitude value; and

roll is the transition range to the maximum.

The most commonly used values are max=10⁻³ DC and roll=10⁻⁴ DC , where DC is the magnitude of the DC signal. The FT of the PSF beyond the depth of field is dominated by these gaps of information, and even the max-limited FDR inverse filter H⁻¹ cannot adequately recover the signal from these noisy regions without allowing noise to dominate the 3D reconstructed image. Since only one half of a revolution of OPT views is needed to perform the filtered back-projection reconstruction, the out-of-focus data can be safely excluded from the OPT sinogram. This is accomplished by creating a roll-off filter that deemphasizes the out-of-focus data along lines of decreasing slope according to Equation 11 below:

$${W}_{r} ( {R}_{x} , {R}_{z} , Φ ) = \{ \begin{matrix}1.0 \text{:} & l = - \frac{Φ}{{R}_{x}} > 0 \\ {cos}^{2} ( \frac{π}{2} \frac{\vert l \vert}{w} ) \text{:} & w > l > 0 \\ 0.0 \text{:} & l > w\end{matrix} \qquad ( 11 )$$

where:

w is a weighting factor from 0.0 to 1.0 that is chosen according to the amount of deemphasis desired. The most commonly used value is w=0.3.

The final inverse filter H⁻¹ is the product of the above individual components as expressed by Equation 12 below:

H_{final}⁻¹=Hₗᵢₘ⁻¹·W_{b}_{ₓ}·W_{b}_{_{z}}·W_{W}·Wᵣ (12)

The roll-off filter has the side effect of creating a weighting function in the reconstructed image space that falls off with the radius of the point source from the centre of rotation of the specimen 16. The final reconstructed image is therefore re-scaled to correct for this effect. A simulation of a circle of constant intensity value equal to 1.0 is passed through the roll-off filtering process Wᵣ and reconstructed with the FBP. The reciprocal of the resulting reconstruction is the normalization coefficient to compensate for the effect of the roll-off filter.

An OPT simulation was used to analyze the reconstruction blur and evaluate the performance of the inverse filter H_{final}⁻. The simulation calculated the position of a point source at a given rotational angle φ, determined the source-to-detector array distance, and simulated the image of the point source by resampling the corresponding 2D lens PSF accordingly. The process was repeated for 2001 OPT views through a complete revolution of the specimen to obtain a full OPT data set.

The 2D PSF of a simulated OPT apparatus was calculated using the XCOSM software package (http://http://www.essrl.wustl.edu/preza/xcosm/), and the PSF was assumed to be shift-invariant in the plane orthogonal to the optical axis of the simulated OPT apparatus. Simulations were performed with the optical parameters NA=0.1 and λ=535 nm. The resolution at best focus of this simulated OPT apparatus is r_{Airy}=3.26 μm. The detector element spacing was set to be e=0.2 μm in order to obtain many pixels across the PSF to aid in evaluating the extent of improvement with the inverse filter H_{final}⁻¹. The depth of field of the simulated OPT apparatus is DOF=54.5 μm, which would accommodate a specimen with a maximum extent dₘₐₓ=109.0 μm.

As noted above, gaps in the frequency space content first appear at source-to-detector array distances located just beyond the wave depth of field. The distance between the gaps on either side of the focus was determined empirically to be equal to the depth of field using a detector element spacing sufficient for the Nyquist criterion, as expressed in Equation 3. The NA of the simulated OPT apparatus was chosen such that this distance was equal to one half of the maximum specimen extent dₘₐₓ. As a result, one half of a revolution of OPT data could be collected without the presence of the frequency space gaps.

As will be appreciated, this distance is larger than the DOFₘₐₓ calculated using the simulated detector element spacing. For this simulation, DOFₘₐₓ=108.9 μm for a specimen with dₘₐₓ=217.8 μm, where DOFₘₐₓ is the DOF calculated if the detector element spacing was just sufficient to meet the Nyquist criterion.

The simulated point source was placed 110 μm from the rotational axis of the specimen, and the focal plane of the simulated lens was placed at a distance of 55.0 μm from the rotational axis of the specimen, in the direction towards the CCD detector array. The simulated detector array comprised of 2501 detector elements for a total field of view of 250.1 μm, and 2001 OPT views were simulated through a complete revolution of the specimen about the rotational axis.

An OPT phantom was created using 4 μm fluorescent silica beads (micromod sicastar-greenF 40-02-403, excitation wavelength=490 nm, emission wavelength=535 nm) embedded in agarose and clarified according to typical OPT procedures as described in the previously mentioned Sharpe et al. reference. OPT data of the beads were acquired using typical OPT imaging parameters to test the 3D case.

Mouse embryos aged E9.5 were fixed with Dent's fixative and immunostained using a Cy3 PECAM antibody stain to mark the embryo vasculature with a red fluorophore. OPT data were acquired to test the resolution of the OPT apparatus.

OPT Imaging

Actual OPT data were acquired using an OPT apparatus that included a Leica MZFLIII stereomicroscope using a Plan 0.5×, 135 mm working distance objective lens (Leica 10446157), and a 1.0× camera lens with an 80 mm tube length (Leica 1445930). The images were recorded by a 1376×1036 pixel (6.45 μm pitch size) Retiga Exi CCD that was thermoelectrically cooled to −40° C. Specimens to be imaged were illuminated by a 100 W mercury vapor arc lamp (Leica 10504069) attached to the microscope housing. A Texas Red filter set (Leica 10446365) was used to isolate the fluorescence of the Cy3 signal. The rotational step size was 0.9°, with a total of 400 OPT images acquired in a complete revolution.

OPT views were acquired using a zoom setting of 5×, a total magnification of 2.5× and an NA of 0.0505. These settings result in a lateral resolution r_{Airy}=7.13 μm for a wavelength λ=590 nm, an effective sampling size of 2.58 μm and a depth of field of DOF=441 μm. The maximum specimen extent is dₘₐₓ=2DOFₘₐₓ. In this case DOFₘₐₓ=471 μm and dₘₐₓ=942 μm.

Exposure time for each OPT view of the beads was 3 s, for a total imaging time of 20 minutes, and exposure time for each OPT view of the mouse embryos was 500 ms, for a total imaging time of 3.5 minutes.

FDR Filtering

During inverse filter construction, the radial PSF of the lens was first calculated for a series of point source distances using the XCOSM software package, then resampled to a 2D grid with the same detector element spacing as the simulated or acquired OPT views. The 2D FFT of the PSFs were calculated in order to obtain the stack of 2D FTs of the 2D PSFs in the coordinate system (Rₓ, R_{z}, l) to enable FDR inverse filter construction. The FDR inverse filter was then constructed as described previously.

The Wiener filter, bandwidth filters, and roll-off filter were calculated as described previously and the reconstructions were intensity re-scaled as described previously.

Filtered Back-projection (FBP) Reconstruction

Reconstructions were performed with parallel ray FBP reconstruction software. The voxel size of the reconstruction was equal to the detector element size of the OPT views.

Image Evaluation

All reconstructed images were inspected visually to evaluate the differences between the original reconstruction and the reconstruction of the filtered OPT sinograms. For the simulated point sources and beads, a line was plotted through the radial, tangential, and z-coordinate axes centring on the beads. The full width at half maximum (FWHM) and full width at 10% maximum (FW10M) were measured in order to compare the filtered results to the unfiltered results.

Results

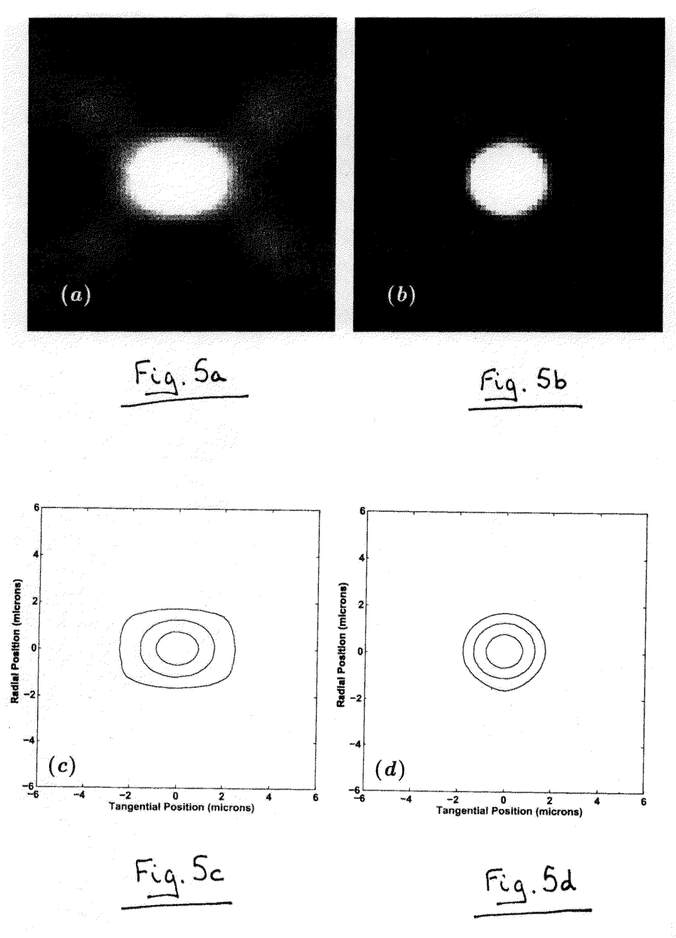

The reconstruction of the 2D simulation of a typical OPT sinogram is shown in FIGS. 5a to 5d as images and contour plots. The reconstructed PSF exhibits a broader tangential spread than radial spread, as listed in the FWHM and FW10M measurements in Table 1 below:

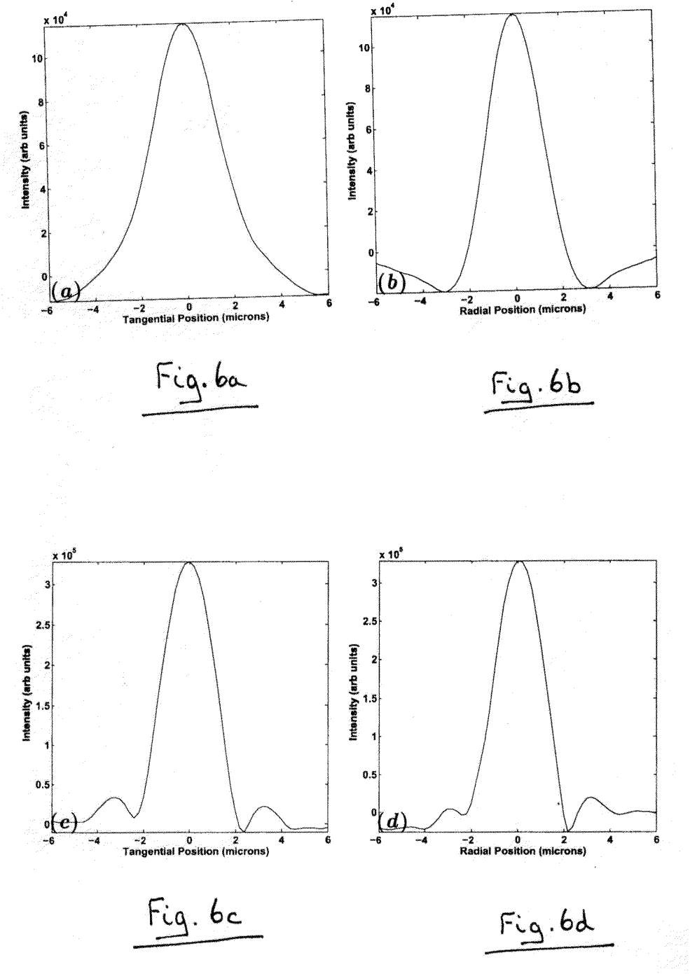

TABLE 1
The FWHM and FW10M of the unfiltered and filtered reconstructions
shown in FIGS. 5a and 5b and plotted in FIGS. 6a to 6d.

| Direction | FWHM(m) | FW10M(m) |
|---|---|---|
| Unfiltered Radial | 1.23 (100%) | 1.87 (100%) |
| Unfiltered Tangential | 1.61 (100%) | 3.07 (100%) |
| Filtered Radial | 0.86 (70.2%) | 1.24 (66.6%) |
| Filtered Tangential | 1.13 (70.1%) | 1.61 (53.7%) |

The four lobes positioned around the reconstructed PSF cause additional blur not represented by the measurements. Plots through the radial and tangential axes are shown in FIGS. 6a to 6d. The reconstructed PSF has visibily narrowed and symmetry has remained about the same at 1:1.3 tangential:radial for the FWHMs, but has improved from 1:1.6 to 1:1.3 at FW10M. Although some ringing has appeared, it is less detrimental to the image than the lobes evident in the unfiltered reconstruction.

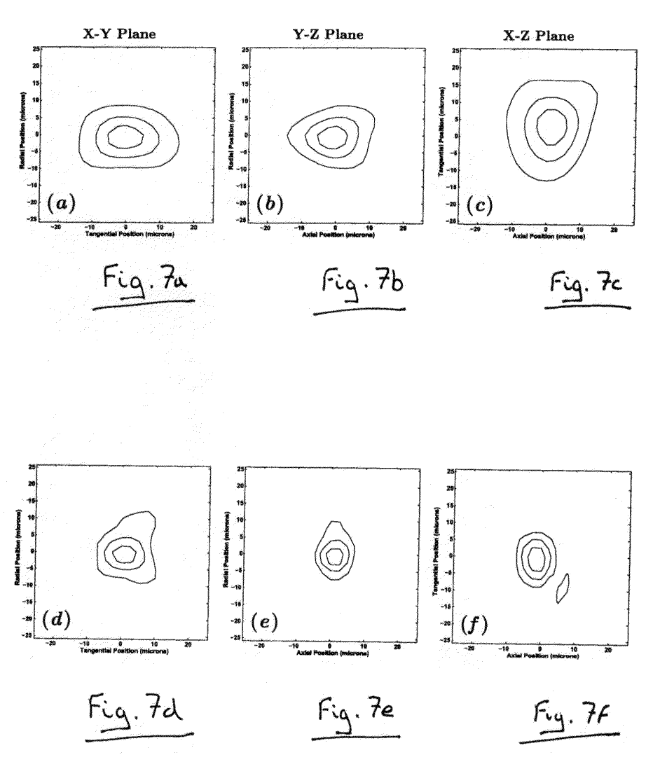

The typical reconstructions of the silica bead is contour plotted in FIGS. 7a to 7c, and the filtered reconstructions of the silica beads is contour plotted in FIGS. 7d to 7f. The measurements of the FWHM and FW reveal improvement along all three axes, as listed in Table 2 below.

TABLE 2
The FWHM and FW10M of the unfiltered and filtered
reconstructions shown in FIGS. 7a to 7f.

| Direction | FWHM(m) | FW10M(m) |
|---|---|---|
| Unfiltered Radial | 18.8 (100%) | 40.6 (100%) |
| Unfiltered Tangential | 15.7 (100%) | 35.0 (100%) |
| Unfiltered Axial | 15.7 (100%) | 35.0 (100%) |
| Filtered Radial | 11.6 (61.7%) | 17.5 (43.1%) |
| Filtered Tangential | 8.7 (55.4%) | 12.8 (36.6%) |
| Filtered Axial | 8.4 (53.5%) | 13.0 (37.1%) |

The radial and tangential measurements have improved to 35-55% and 40-60% of the original measurement, respectively. The axial measurement, which was not measurable in the 2D scenario, shows improvement by 35-55%. The volume of the reconstructed PSF at half-maximum is 18.9% of the original, and the volume at 10% maximum is 5.9% of the original measurement. Symmetry has improved noticeably.

It will be appreciated that this test scenario applies only to a point source on the periphery of the imaged specimen. The distance dependent PSF of the lens results in radially-dependent reconstructed PSFs, each of which undergoes different degrees of improvement. The periphery of the specimen is studied as it is expected to undergo the most defocusing and hence, results in the most blurred reconstruction.

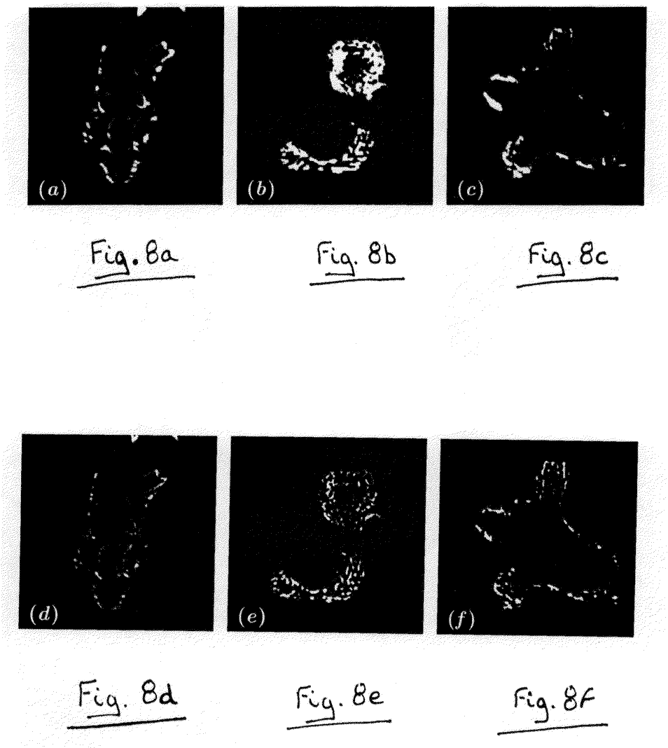

The biological specimen was imaged to test not only the effects on a fine detailed structure, but also to evaluate the performance of the inverse filter across all radii from the rotational axis of the container. The improvements due to filtering are most noticeable in the reconstructed images of the mouse embryos. In the initial OPT reconstruction of the mouse embryonic vasculature, as shown in FIG. 8a, the vessels near the rotational axis were visible and recognizable, but the vessels near the exterior were unrecognizable as blur dominates the image. Filtering the OPT data in the manner described above improves not only the vessels near the periphery, as shown in FIG. 8d, but also the vessels near the rotational axis as well. Orthogonal image planes of the original reconstruction, shown in FIGS. 8b and 8c, and the filtered reconstructions, shown in FIGS. 8e and 8f, exhibit similar improvement along the axial direction.

As will be appreciated, the use of a frequency space filter based on the frequency-distance relationship improves the resolution of reconstructed OPT images. The inverse filter deemphasizes and excludes out-of-focus data obtained from the specimen outside of the depth of field of the OPT apparatus, deemphasizes frequency components that are dominated by noise, and deconvolves the distance-dependent point spread function from images of the specimen within the depth of field. OPT reconstructions of simulated point sources demonstrate reconstruction point spread functions with reduced FWHM and FW10M in all axes, with a noticeable improvement in symmetry. Though some ringing is evident, it minimally degrades the reconstructed image. The advantages of the inverse filter can clearly be seen when applied to the experimental OPT data.

The OPT image data processing software includes computer executable instructions executed by the processing structure. The software application may include program modules including routines, programs, object components, data structures etc. and be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

In the embodiment described above, emission OPT images are generated. Those of skill in the art will appreciate that transmission OPT images may be generated.

Although embodiments have been described above with reference to the accompanying drawings, those of skill in the art will appreciate that variations and modifications may be made without departing from the spirit and scope thereof as defined by the appended claims.

1. A method of reducing blur in an optical projection tomography (OPT) image comprising:
filtering the frequency space information of OPT image data to reduce the effects of out-of-focus data and defocused in-focus data; and
reconstructing the filtered OPT data.

2. The method of claim 1 wherein said filtering also reduces the effects of defocused in-focus data.

3. The method of claim 2 wherein said filtering comprises:
excluding out-of-focus data and narrowing the point spread function of in-focus data.

4. The method of claim 3 wherein the filtered OPT data are OPT sinograms.

5. The method of claim 3 wherein said filtering comprises deemphasizing noise.

6. The method of claim 5 wherein frequency components dominated primarily by noise are deemphasized.

7. The method of claim 6 wherein said deemphasizing comprises excluding high frequency components that contain no data.

8. The method of claim 5 wherein said deemphasizing is performed by a Wiener filter.

9. The method of claim 3 wherein out-of-focus data is excluded using a slope-based roll-off filter.

10. The method of claim 5 wherein said filtering comprises inhibiting noise in gaps at certain frequencies from being emphasized.

11. The method of claim 10 wherein said inhibiting comprises scaling filtering vectors by a weighting function.

12. An optical projection tomography apparatus comprising:
a light source;
optics for focusing light emitted by the light source onto a specimen thereby to illuminate said specimen, said specimen being rotated through steps;
a microscope gathering light from said illuminated specimen at each step;
an image sensor receiving the gathered light from said microscope at each step and generating OPT image data; and
processing structure processing the OPT image data to reduce at least the effect of out-of-focus data and reconstructing the processed OPT image data thereby to yield a volumetric representation of said specimen.

13. An apparatus according to claim 12 wherein said processing structure processes the OPT image data to reduce the effect of in-focus data that has been defocused.

14. An apparatus according to claim 13 wherein said processing structure processes the OPT image data to exclude out-of-focus data and to narrow the point spread function of in-focus data.

15. An apparatus according to claim 14 wherein said processing structure employs a multi-component filter to process the OPT image data.

16. An apparatus according to claim 15 wherein said multi-component filter also deemphasizes noise in said OPT image data.

17. An apparatus according to claim 16 wherein said multi-component filter deemphasizes frequency components dominated by noise.

18. An apparatus according to claim 17 wherein said multi-component filter inhibits noise in gaps at certain frequencies from being emphasized.

19. An apparatus according to claim 15 wherein said multi-component filter comprises four components.

20. An apparatus according to claim 19 wherein said four components comprise a max-limited recovery filter, a bandlimiting roll-off filter at high frequencies, a Wiener filter and a slope-based roll-off filter.

21. A computer readable medium embodying a computer program comprising computer program code that when executed performs the method of claim 1.
